(19) United States
(12) Patent Application Publication
(10) Pub. No.: US 2011/0176486 A1
(43) Pub. Date: Jul. 21, 2011

(54) System and Method for Reporting Trusted Access Network Information

(75) Inventor: Kaniz Mahdi, Carrollton, TX (US)

(73) Assignee: FutureWei Technologies, Inc., Plano, TX (US)

(21) Appl. No.: 13/009,756

(22) Filed: Jan. 19, 2011

Related U.S. Application Data
(60) Provisional application No. 61/296,362, filed on Jan. 19, 2010.

(51) Int. Cl. H04L 12/66

(52) U.S. Cl. 370/328

(57) ABSTRACT

A system and method for reporting trusted access network information are provided. A method for network entity operations includes setting up a session with a communications device, subscribing to location reports for the communications device, and receiving a location report for the communications device. The subscribing includes sending an indication of the subscription in a message passed during the setting up of the session or at network registration.

This application claims the benefit of U.S. Provisional Application No. 61/296,362, filed Jan. 19, 2010, entitled “System and Method for Reporting Trusted 3GPP Access Network Information to IMS Elements,” which application is hereby incorporated herein by reference.

### TECHNICAL FIELD

The present invention relates generally to digital communications, and more particularly to a system and method for reporting trusted access network information.

### BACKGROUND

In a Third Generation Partnership Project (3GPP) compliant communications system, trusted access network information, such as cell identifier information (cell id) and/or specific location information for a Serving Area Interface (SAI), may be reported by access network nodes, e.g., enhanced NodeB (eNB) in Evolved Universal Terrestrial Radio Access Network (e-UTRAN) and Radio Network Controller (RNC) in Universal Terrestrial Radio Access Network (UTRAN), to Internet Protocol (IP) Multimedia Subsystem (IMS) elements, for example, a Proxy-Call Session Control Function (P-CSCF) and a Serving CSCF (S-CSCF).

The trusted access network information, such as cell id and/or SAI, may be used by an IMS domain for purposes such as lawful interception (e.g., wiretapping), emergency services (for example, 911, enhanced 911), location based service (zone based information delivery, location based advertisement, news, weather, and so forth).

Currently, location information may be provided by a third party entity residing outside of an operator's communications network through information push type of operation. However, the third party entity and the location information that it provides may or may not be trusted implicitly.

Therefore, there is a need for a system and method for subscribing to location information from trusted information sources, rather than from a third party entity, which may or may not be trusted.

### SUMMARY OF THE INVENTION

These and other problems are generally solved or circumvented, and technical advantages are generally achieved, by example embodiments of the present invention which provide a system and method for reporting trusted access network information.

In accordance with an example embodiment of the present invention, a method for network entity operations is provided. The method includes setting up a session with a communications device, subscribing to location reports for the communications device, and receiving a location report for the communications device. The subscribing includes sending an indication of a subscription in a message passed during the setting up of the session or at network registration.

In accordance with another example embodiment of the present invention, a method for network entity operations is provided. The method includes receiving a subscription for trusted access network information related to a communications device, sending information related to the subscription to a network core, receiving the trusted access network information, and forwarding the trusted access network information.

In accordance with another example embodiment of the present invention, a network entity is provided. The network entity includes a session setup unit, a subscription unit coupled to the session setup unit, and a location unit coupled to the subscription unit. The session setup unit is coupled to a receiver and to a transmitter, and setups a session with a communications device, the subscription unit subscribes to location reports for the communications device, and sends an indication of the subscription during the setting up of the session, and the location unit receives a location report for the communications device.

One advantage disclosed herein is that the access network information is provided by a trusted network entity so that the access network information may be trusted implicitly.

A further advantage of exemplary embodiments is that a subscription to the access network information may be configured so that the access network information may be provided in a periodic manner or whenever the access network information changes.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 illustrates an example diagram of a communications network;

FIG. 2 illustrates an example diagram of a communications network with operations for reporting trusted access network information highlighted according to example embodiments described herein;

FIG. 3 illustrates an example message flow diagram in the reporting of trusted access network information according to example embodiments described herein;

FIG. 4 illustrates an example flow diagram of operations occurring in an IMS in the reporting of trusted access network information according to example embodiments described herein;

FIG. 5 illustrates an example flow diagram of operations occurring in a PCC in the reporting of trusted access network information according to example embodiments described herein;

FIG. 6 illustrates an example diagram of a first network entity according to example embodiments described herein; and

FIG. 7 illustrates an example diagram of a second network entity according to example embodiments described herein.

### DETAILED DESCRIPTION OF ILLUSTRATIVE EMBODIMENTS

The making and using of the current example embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to example embodiments in a specific context, namely a communications network that includes a 3GPP compliant communications system operating in an IMS domain. The invention may also be applied, however, to other communications networks that include other communications systems, such as WiMAX, and so on, operating in an IMS domain.

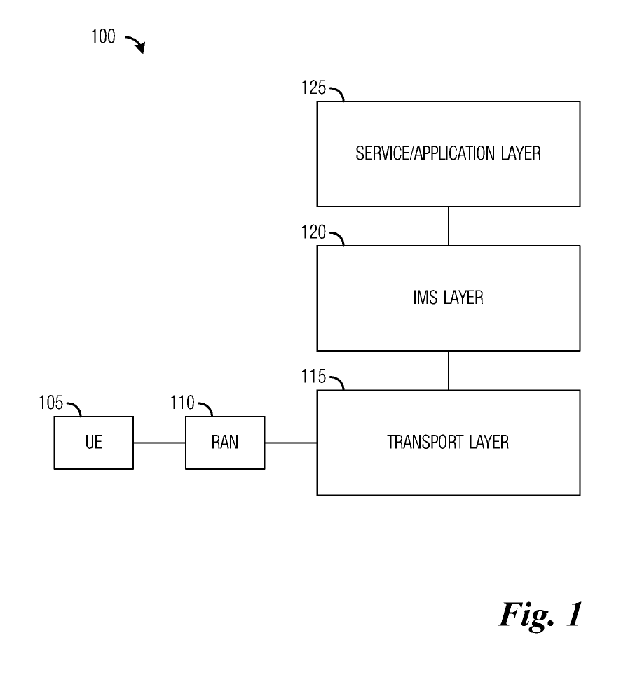

FIG. 1 illustrates a communications network 100. Communications network 100 includes a User Equipment (UE) 105 that is connected via a Radio Access Network (RAN) 110 to an IMS network. The IMS network includes a transport layer 115 that may be responsible for transporting information, such as data packets, an IMS layer 120 that may be responsible for defining (and providing) functions to handle signaling and subscriber traffic for multimedia applications, and a service/application layer 125 that may be responsible for providing different content services and applications as well as generic service enablers.

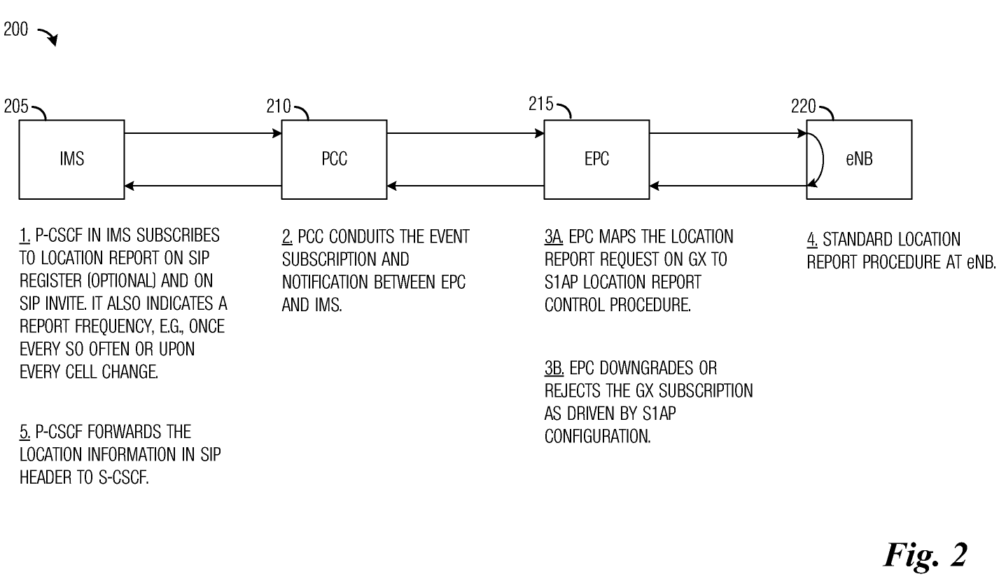

FIG. 2 illustrates a communications network 200 with operations for reporting trusted access network information highlighted. Communications network 200 includes an IMS 205, a Policy and Charging Control (PCC) 210, an Evolved Packet Core (EPC) 215, and an eNB 220.

Reporting trusted access network information may begin with a Proxy Call Session Control Function (P-CSCF), located in IMS 205, which may subscribe to location reports for a UE (shown as Event 1). The IMS 205 may send the subscription to PCC 210. According to an example embodiment, the P-CSCF may subscribe to the location reports for the UE through a Session Initiation Protocol (SIP) INVITE message, or optionally through a SIP REGISTER message. The P-CSCF may include a parameter in the SIP INVITE message or the SIP REGISTER message. As an example, the parameter may be “Location Report Event Subscription”. The parameter may be an enhancement of an existing receiver or Rx interface AA-Request (AAR) Attribute Value Pair (AVP), such as an IP-CAN_CHANGE AVP, or a new AVP.

In addition to subscribing to the location reports, the P-CSCF may also specify a frequency of the location reports. For example, the P-CSCF may specify a period of the location reports, e.g., once every N seconds. Alternatively, the P-CSCF may specify that a location report is generated each time that a trigger occurs. For example, a trigger may be when there is a cell change for the UE (i.e., a change of location), when a manual location request is made, during certain times of the day, when an emergency advisory action is made (e.g., a National Weather Advisory), and so on.

PCC 210 may serve as a conduit and send the subscription to EPC 215 (shown as Event 2). In general, PCC 210 may serve as a conduit between EPC 215 and IMS 205.

EPC 215 may map the location report request on a GX interface to an S1 Application Protocol (S1AP) location report control procedure (shown as Event 3A). Furthermore, EPC 215 may either downgrade or reject the GX interface location report request as driven by the S1AP location report control procedure (shown as Event 3B).

As part of the S1AP location report control procedure, eNB 220 receives a location report request message. eNB 220 may then execute a standard location report procedure (shown as Event 4). Information provided by the location report procedure, such as cell id and/or SAI, may then be propagated back to IMS 205 through EPC 215 and PCC 210.

At IMS 205, the P-CSCF may forward the information (the location information) to a Serving CSCF (S-CSCF) (shown as Event 5). According to an example embodiment, the information may be transmitted in SIP headers. The S-SCSF may serve the information as needed, based on requester of the information.

The network entities shown in FIG. 2 are e-UTRAN network entities. A similar diagram may be created using GERAN/UTRAN network entities. Therefore, the illustration of e-UTRAN network entities should not be construed as being limiting to either the scope or the spirit of the embodiments.

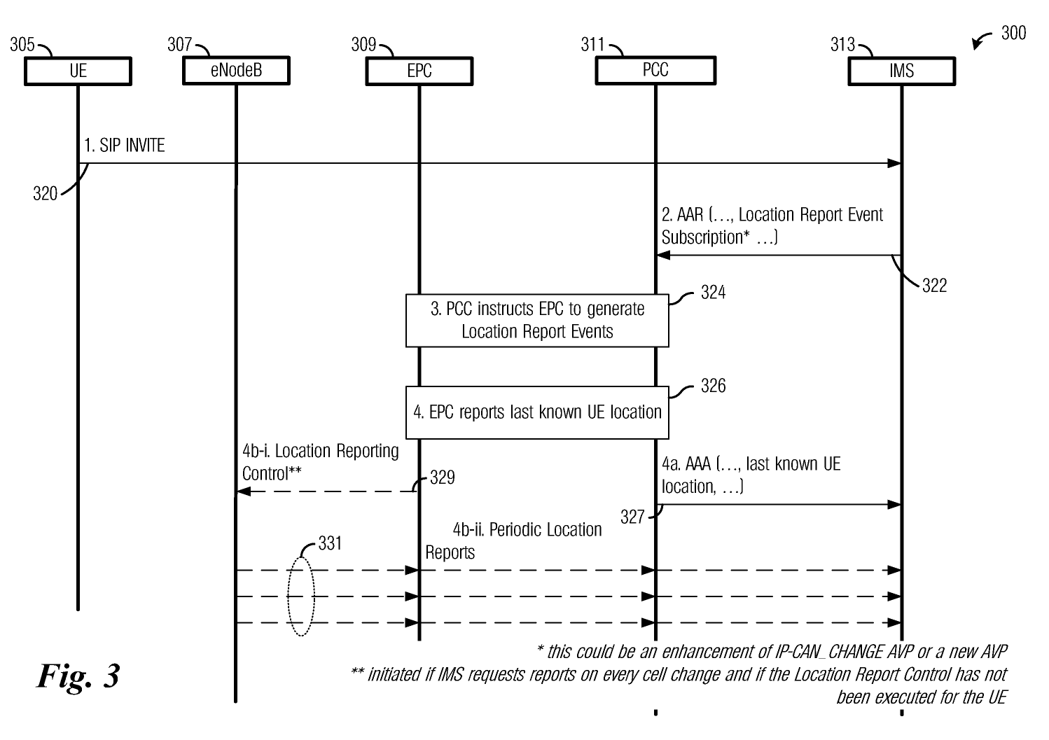

FIG. 3 illustrates a message flow diagram 300 in the reporting of trusted access network information. Message flow diagram 300 indicates messages exchanged between various network entities in a communications network that are involved in the generating and report of trusted access network information, such as cell id and/or SAI. Message flow diagram 300 involves messages exchanged between a UE 305, an eNB 307, an EPC 309, a PCC 311, and an IMS 313.

The reporting of trusted access network information may begin with an establishment of a session (event 320). Establishment of the session may be initiated by UE 305 and may involve a transmission of a message, typically a SIP INVITE, to IMS 313. IMS 313, which may be desirous to receive trusted access network information related to UE 305, may respond to the establishment of the session with UE 305 with an AA-Request (AAR) message sent to PCC 311 (event 322). According to an example embodiment, the AAR message may include a parameter that is set to a location report event subscription. The parameter used to indicate the location report event subscription may be an enhancement of an existing AVP, for example, an IP-CAN CHANGE AVP, or an entirely new AVP.

PCC may, upon receipt of the AAR message from IMS 313, instruct EPC 309 to generate location report events (event 324). According to an example embodiment, EPC 309 may generate location report events based on a frequency specified by IMS 313 that is included in the AAR message. Alternatively, EPC 309 may configure the location report events to occur whenever there is a cell change associated with UE 305, or when some other desired event occurs.

EPC 309 may then report a last known location information for UE 305 (event 326). Reporting the last known location information for UE 305 may involve EPC 309 sending the location information to PCC 311, which may then provide the location information to IMS 313 in a message, preferably an AA-Answer (AAA) message (event 327).

Additionally, in response to the location report subscription initiated by IMS 313, EPC 309 may initiate a location reporting control procedure with eNB 307, which controls UE 305 (event 329). According to an example embodiment, EPC 309 initiates the location reporting control procedure if IMS 313 requests location reports on every cell change of UE 305 and if location report control has not already been executed for UE 309.

Then, at periodic intervals (as specified by IMS 313) or upon changes in cell for UE 305 or other defining event, eNB 307 may provide updated location reports to EPC 309, which in turn, reports the updated location reports to PCC 311, which in turn, reports the updated location reports to IMS 313 (collectively events 331).

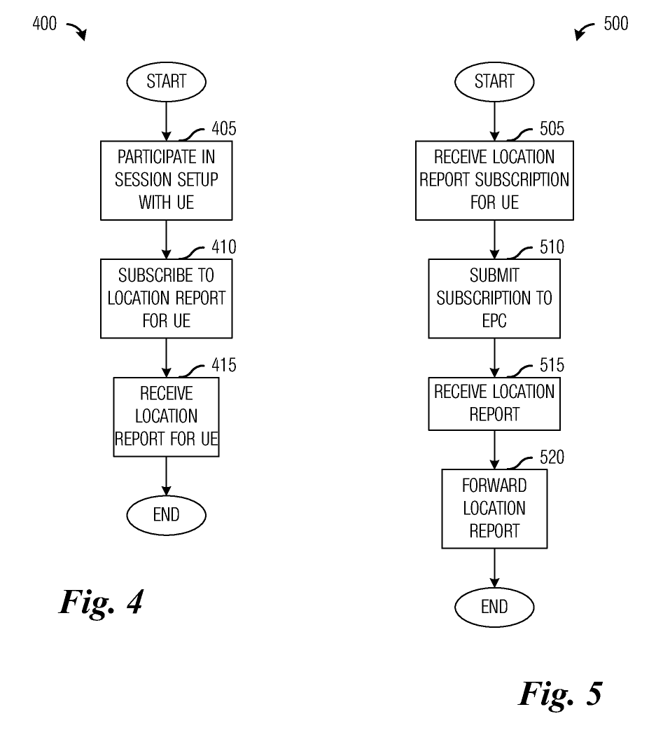

FIG. 4 illustrates a flow diagram of operations 400 occurring in an IMS in the reporting of trusted access network information. Operations 400 may be indicative of operations occurring in an IMS, such as IMS 313, in the reporting of trusted access network information. Operations 400 may occur while the IMS is in a normal operating mode.

Reporting of trusted access network information may begin with the IMS participating in a session setup with a UE (block 405). According to an example embodiment, the session setup may part of a SIP INVITE procedure.

With the session setup complete, the IMS may subscribe to a location report for the UE (block 410). According to an example embodiment, a P-CSCF in the IMS may subscribe to location reports for the UE using a SIP INVITE procedure or a SIP REGISTER procedure. The P-CSCF may also indicate a desired frequency for the location reports and/or specify that the location reports are initiated by a cell change or other event for the UE.

After subscribing to the location reports, the IMS may receive location reports, either periodically or when there is an event occurrence or status change (e.g., cell change) for the UE (block 415). Wherein after, operations 400 may then terminate.

FIG. 5 illustrates a flow diagram of operations 500 occurring in a PCC in the reporting of trusted access network information. Operations 500 may be indicative of operations occurring in a PCC, such as PCC 311, in the reporting of trusted access network information. Operations 500 may occur while the PCC is in a normal operating mode.

Reporting of trusted access network information may begin with the PCC receiving a message from an IMS containing a subscription for location reports for a UE (block 505). According to an example embodiment, the subscription may also indicate a desired frequency for the location reports and/or specify that the location reports are initiated by some type of event (e.g., a cell change) for the UE. The PCC may forward the message containing the subscription to an EPC (block 510).

The PCC may subsequently receive a location report for the UE from the EPC (block 515). The location report may be a periodic location reports or a result of some event (e.g., a cell change) defined for the UE. The PCC may forward the location report to the IMS (block 520). Wherein after, operations 500 may then terminate.

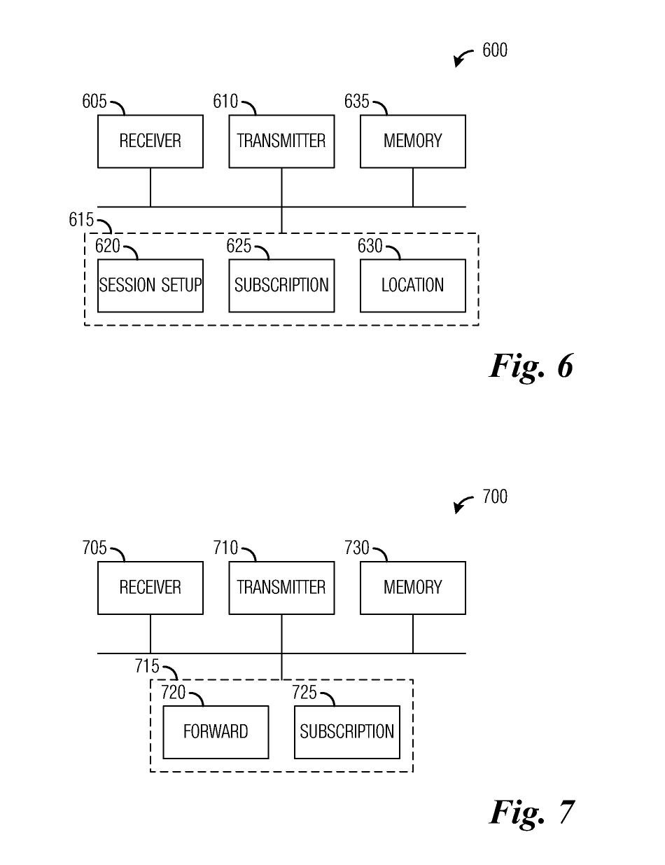

FIG. 6 provides an alternate illustration of a network entity 600. Network entity 600 may be an implementation of an IMS. Network entity 600 may be used to implement various ones of the embodiments discussed herein. As shown in FIG. 6, a receiver 605 is configured to receive information and a transmitter 610 is configured to transmit information. Receiver 605 and transmitter 610 may be wireless, wireline, or a combination thereof.

A session setup unit 620 is configured to setup a session, such as a SIP session with a UE. A subscription unit 625 is configured to setup a location report subscription for location information related to the UE. Subscription unit 625 may specify a period of the location reports for the UE. Alternatively, subscription unit 625 may specify that a location report may occur when there is an event (e.g., a cell change) defined by or for the UE. A location unit 630 is configured to process the location information received in the location reports, providing the location information to requesters of the location information. A memory 635 stores session information, subscription information, location information, and so forth.

The elements of network entity 600 may be implemented as specific hardware logic blocks. In an alternative, the elements of network entity 600 may be implemented as software executing in a processor, controller, application specific integrated circuit, or so on. In yet another alternative, the elements of network entity 600 may be implemented as a combination of software and/or hardware.

As an example, receiver 605 and transmitter 605 may be implemented as a specific hardware block, while session setup unit 620, subscription unit 625, and location unit 630 may be software modules executing in a microprocessor (such as processor 615) or a custom circuit or a custom compiled logic array of a field programmable logic array.

FIG. 7 provides an alternate illustration of a network entity 700. Network entity 700 may be an implementation of a PCC. Network entity 700 may be used to implement various ones of the embodiments discussed herein. As shown in FIG. 7, a receiver 705 is configured to receive information and a transmitter 710 is configured to transmit information. Receiver 705 and transmitter 710 may be wireless, wireline, or a combination thereof.

A forward unit 720 is configured to forward information received by network entity 700 to another network entity. For example, forward unit 720 forwards location reports from an EPC to an IMS or a subscription from the IMS to the EPC. A subscription unit 725 is configured to setup a location report subscription for location information related to the UE based on a subscription request from the IMS. Subscription unit 725 may configure a period of the location reports for the UE. Alternatively, subscription unit 725 may configure that a location report may occur when there is a cell change for the UE. A memory 730 stores information prior to forwarding, subscription requests, and so on.

The elements of network entity 700 may be implemented as specific hardware logic blocks. In an alternative, the elements of network entity 700 may be implemented as software executing in a processor, controller, application specific integrated circuit, or so on. In yet another alternative, the elements of network entity 700 may be implemented as a combination of software and/or hardware.

As an example, receiver 705 and transmitter 705 may be implemented as a specific hardware block, while forward unit 720, and subscription unit 725 may be software modules executing in a microprocessor (such as processor 715) or a custom circuit or a custom compiled logic array of a field programmable logic array.

The above described embodiments of network entities 600 and 700 may also be illustrated in terms of methods comprising functional steps and/or non-functional acts. The previous description and related flow diagrams illustrate steps and/or acts that may be performed in practicing example embodiments of the present invention. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the flow diagrams(s) for FIGS. 4 and 5—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for network entity operations, the method comprising:
setting up a session with a communications device;
subscribing to location reports for the communications device, wherein the subscribing comprises sending an indication of a subscription in a message passed during the setting up of the session or at network registration; and
receiving a location report for the communications device.

2. The method of claim 1, further comprising receiving an additional location report subsequent to a change of location of the communications device.

3. The method of claim 1, wherein setting up a session comprises receiving a session initiation protocol (SIP) invite message from the communications device.

4. The method of claim 3, wherein subscribing to location reports comprises sending the indication in an AA-Report (AAR) message.

5. The method of claim 4, wherein the AAR message is sent to an Evolved Packet Core.

6. The method of claim 5, wherein the AAR message is sent to a Policy and Charging Control prior to the Evolved Packet Core.

7. The method of claim 3, wherein subscribing to location reports comprises sending the indication in a SIP REGISTER message.

8. The method of claim 1, wherein the indication comprises a period for the location reports.

9. The method of claim 1, wherein the indication indicates that a location report occurs only when a trigger occurs.

10. The method of claim 9, wherein the trigger comprises a cell change for the communications device.

11. The method of claim 1, wherein a Proxy Call Session Control Function initiates the subscription to location reports.

12. The method of claim 11, wherein the Proxy Call Session Control Function is part of an Internet Protocol Multimedia Subsystem.

13. The method of claim 11, wherein the Proxy Call Session Control Function receives a location report in a SIP message, and wherein the Proxy Call Session Control Function forwards the location report to a Serving Call Session Control Function.

14. A method for network entity operations, the method comprising:
receiving a subscription for trusted access network information related to a communications device;
sending information related to the subscription to a network core;
receiving the trusted access network information; and
forwarding the trusted access network information.

15. The method of claim 14, wherein receiving a subscription comprises receiving a message comprising an indication of the subscription.

16. The method of claim 15, wherein the indication comprises a period for reporting the trusted access network information or a trigger for reporting the trusted network information.

17. The method of claim 16, wherein the trigger comprises a cell change for the communications device.

18. The method of claim 15, wherein sending information comprises specifying occurrences of reports of the trusted access network information.

19. A network entity comprising:
a session setup unit configured to be coupled to a receiver and to a transmitter, and to setup a session with a communications device;
a subscription unit coupled to the session setup unit, the subscription unit configured to subscribe to location reports for the communications device, and to send an indication of the subscription during the setting up of the session; and
a location unit coupled to the subscription unit, the location unit configured to receive a location report for the communications device.

20. The network entity of claim 19, wherein the session setup unit sets up the session by receiving a session initiation protocol invite message from the communications device.

21. The network entity of claim 20, wherein the subscription unit sends the indication in an AA-Report message or a session initiation protocol register message.

22. The network entity of claim 19, wherein the indication comprises a period for the location reports or a trigger of a location report.

23. The network entity of claim 19, wherein the location unit configured to process the location report.
